(19) United States
(12) Patent Application Publication
(10) Pub. No.: US 2012/0079197 A1
(43) Pub. Date: Mar. 29, 2012

(54) CARD-READING DEVICE AND METHOD FOR USING THE CARD-READING DEVICE TO ACCESS MEMORY CARD

(75) Inventor: Su-Yi Cheng, Daxi Township (TW)

(73) Assignee: DATFAB SYSTEM INC., Pingzhen City (TW)

(21) Appl. No.: 12/892,921

(22) Filed: Sep. 28, 2010

(51) Int. Cl. G06F 12/00

(52) U.S. Cl. 711/115

(57) ABSTRACT

The present invention relates to a card-reading device and a method for using the card-reading device to access a memory card, the card-reading device comprises: a central processing unit; at least one connecting unit; at least two interface unit, comprising a first interface unit connecting to the central unit and the connecting unit, and a second interface unit connecting to the central processing unit; and at least one accommodating unit, adapted for accommodating an external memory card. Moreover, through the method, a first electronic device or a second electronic device is able to access the memory card accommodated by the card-reading device.

### BACKGROUND OF THE INVENTION

1. Technical Field

The present invention relates to a card-reading device, and more particularly, to a card-reading device with at least two connecting interface and capable of being selectively inserted into an USB connection port of a computer or a memory connection port of a cell phone.

2. Description of Related Art

With the evolution of the times, the development of technologies has a great progress, in particular, the electronic products relate to digital technologies are invented and used in human life, such as digital camera, mobile phone and multimedia player. However, it needs a memory card for storing electronic documents and digital data when using the aforesaid digital electronic products. Since different manufacturers make a wide variety of memory card applied in the digital electronic products, memory cards are divided to MMC card, SD card, SM/xD card, CF card, MS card, and other memory cards which are designed based on the aforesaid memory cards.

Generally, the memory card can be directly inserted into a memory card slot of the digital electronic product, and then the digital electronic product is able to access the memory card. The memory card can not be directly connected to a computer, however, a card reader and an USB connector are must be used if it desires to make the memory card connect to the computer. Thus, by means of the card reader and the USB connector, the computer is able to access the memory card and backup the data stored in the memory card.

For example, the memory card applied in the mobile phone is usually a micro SD card having a small size. When a user desires to backup the data stored in the micro SD card, firstly, the user needs to withdraw the micro SD card from the memory card slot of the mobile phone, then, to insert the micro SD card into the card reader having the USB connector, and then to connect the USB connector with an USB connection port of the computer; therefore, the user is able to backup the data stored in the micro SD card by operating the computer. After the data backup is completed, the user needs to remove the card reader from the USB connection port of the computer firstly, then, the user needs to withdraw the micro SD card from the card reader, and then, to insert the micro SD card into the memory card slot of the mobile phone; so that, the digital data processed by the mobile phone is capable of being stored into the micro SD card.

According to the above mention, it is able to know that, since the single card reader or single memory card does not be compatible with the memory card slot of the mobile phone and the USB connection port of the computer, so that, it makes the user need to execute the complex steps for inserting and withdrawing the memory card in order to backup the data, that brings much inconvenience to the user. Besides, after several of the inserting and removing of the memory card, the metal pins of the memory card are damaged, so as to reduce the lifetime of the memory card.

Accordingly, in view of the conventional memory card and card reader have shortcomings and drawbacks, the inventor of the present application has made great efforts to make inventive research thereon and eventually provided a card-reading device and a method for using the card-reading device to access a memory card.

### BRIEF SUMMARY OF THE INVENTION

The first objective of the present invention is to provide a card-reading device capable of being perfectly combined with a memory card, and having at least two interface, including an USB interface for connecting to an USB connection port of a computer, and a memory card interface for connecting to a memory card connection port of a cell phone, such that, the card-reading device can be connected to the computer or the cell phone without any other conversion interfaces/devices.

The second objective of the present invention is to provide a card-reading device having a flip housing, so that a user can easily to dispose a memory card into the housing, or to withdraw the memory card from the housing, moreover, by way of a blocking portion, the memory card is protected from sliding out.

The third objective of the present invention is to provide a card-reading device, in which, the memory card interfaces with the same width sizes of metal pins are integrated in one single interface unit of the card-reading device, so that the single interface unit is compatible with at least two kinds of memory card.

The fourth objective of the present invention is to provide a method for using a card-reading device to access a memory card, through the method, the card-reading device can selectively be inserted into an USB connection port or a memory card connection port, such that a notebook (computer) or a cell phone can access memory card accommodated in the card-reading device.

Accordingly, to achieve the abovementioned first objective, second objective and third objective, the inventor proposes a card-reading device, comprising: a central processing unit; at least one connecting unit; at least two interface unit, having a first interface unit connecting to the central processing unit and the connecting unit, and a second interface unit connecting to central processing unit; and at least one accommodating unit, adapted for accommodating an external memory card; wherein the first interface unit is compatible with memory card, and the memory card may connect to the first interface unit via the connecting unit; moreover, through the central processing unit, the memory card is capable of connecting to the second interface unit.

Moreover, to achieve the aforesaid fourth objective, the inventor proposes a method for using a card-reading device to access a memory card, the method comprises the steps of: (1) inserting a memory card into an accommodating unit of a card-reading device; (2) the memory card electrically connects to a connecting unit; (3) the memory card electrically connects to a first interface unit via the connecting unit; (4) through the central processing unit, the memory card electrically connecting to a second interface unit; (5) determining whether disposing the card-reading device into a memory card connection port of a first electronic device, if yes, proceeding to step (6), and otherwise, proceeding to step (7); (6) the first electronic device accesses the memory card by way of the first interface unit and the connecting unit; (7) determining whether disposing the card-reading device into an USB connection port of a second electronic device, if yes, proceeding to step (8), and otherwise, ending the steps; and (8) the second electronic device accesses the memory card by means of the second interface unit and the central processing unit.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a block framework diagram of a card-reading device according to the present invention;

FIG. 2 is a partial stereo diagram of a practical embodiment of the card-reading device according to the present invention;

FIG. 3 is a second partial stereo diagram of the practical embodiment of the card-reading device according to the present invention;

FIG. 4 is a whole stereo diagram of the practical embodiment of the card-reading device according to the present invention;

FIG. 5 is a schematic diagram of a memory card being accommodated in the card-reading device;

FIG. 6 is the schematic diagram of the card-reading device being combined with a first electronic device;

FIG. 7 is the schematic diagram of the card-reading device being combined with a second electronic device;

FIG. 8 is a second stereo diagram of the practical embodiment of the card-reading device according to the present invention;

FIG. 9 is the stereo diagram of a second embodiment of the card-reading device according to the present invention;

FIG. 10 is the stereo diagram of a third embodiment of the card-reading device according to the present invention;

FIG. 11 is the stereo diagram of a fourth embodiment of the card-reading device according to the present invention;

FIG. 12 is the block framework diagram of the fourth embodiment of the card-reading device according to the present invention; and

FIGS. 13A and 13B are flow chart diagrams of a method for using the card-reading device to access the memory card according to the present invention.

### DETAILED DESCRIPTION OF THE INVENTION

To more clearly describe a card-reading device and a method for using the card-reading device to access a memory card according to the present invention, embodiments of the present invention will be described in detail with reference to the attached drawings hereinafter.

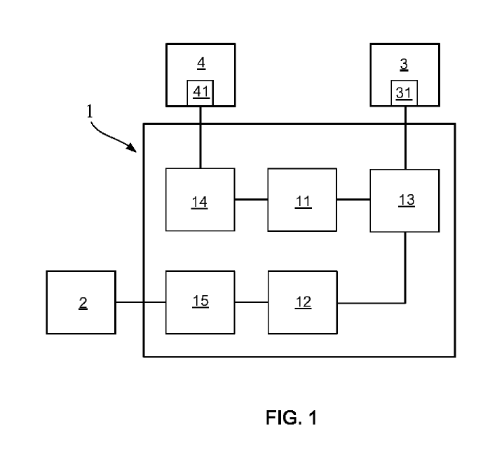

With reference to FIG. 1, which illustrates a block framework diagram of a card-reading device according to the present invention, as shown in FIG. 1, the card-reading device 1 includes: a central processing unit 11, a connecting unit 12, two interface unit, and an accommodating unit 15, wherein the two interface unit are a first interface unit 13 connecting to the central processing unit 11 and the connecting unit 12, and a second interface unit 14 connecting to the central processing unit 11, respectively. The accommodating unit 15 is adapted for accommodating an external memory card 2, wherein the first interface unit 13 is compatible with the memory card 2 when the memory card 2 is disposed in the accommodating unit 15, and the memory card 2 electrically connects to the first interface unit 13 via the connecting unit 12; moreover, through the central processing unit 11, the memory card 2 connects to the second interface unit 14

In the above block framework of the card-reading device 1, the first interface unit 13 is a memory card interface unit capable of connecting to a memory card connection port 31 of a first electronic device 3, such that the first electronic device 3 can access the memory card 2 by way of the first interface unit 13 and the connecting unit 12. The first electronic device 3 can be a cell phone, a host, a notebook, a multimedia player, a digital camera, or a multi-card reader, having the memory card connection port 31 for being inserted the memory card or the present card-reading device 1. The second interface unit 14 is an USB interface unit capable of connecting to an USB connection port of a second electronic device 4, and then the second electronic device 4 is able to access the memory card 2 through the second interface unit 14 and the central processing unit 11, wherein the second electronic device 4 can be the host, a notebook or a multimedia player having the USB connection port 41.

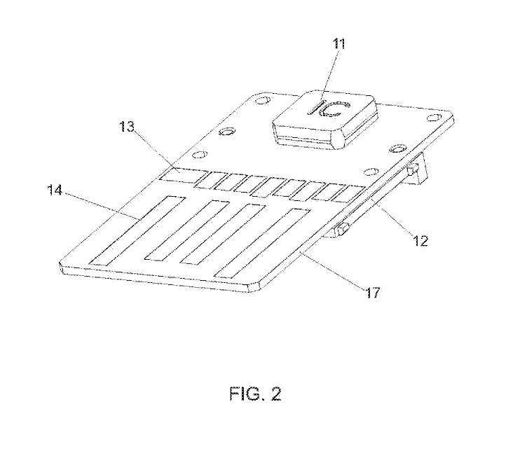

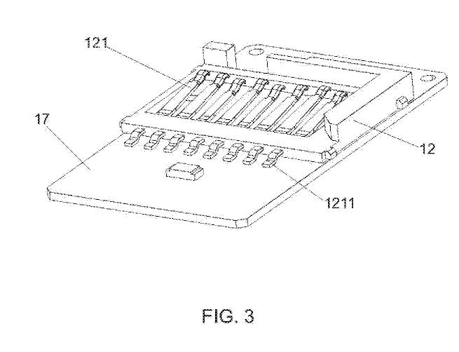

In order to the practically implement the card reader device 1 of the present invention, please refer to FIG. 2, which illustrates a partial stereo diagram of a practical embodiment of the card-reading device according to the present invention, moreover, with reference to FIG. 3, which illustrates a second partial stereo diagram of the practical embodiment of the card-reading device according to the present invention. As shown in FIG. 2 and FIG. 3, the central processing unit 11, the connecting unit 12, the first interface unit 13, and the second interface unit 14 can be implemented on a printed circuit board 17, wherein the central processing unit 11, the first interface unit 13 and the second interface unit 14 are disposed on a positive surface of the printed circuit board 17, and the connecting unit 12 is disposed on an negative surface of the printed circuit board 17.

Besides, as shown in FIG. 2, the first interface unit 13 is made up of a plurality of metal pins, and a width size of the metal pins are ranged between 10 mm to 40 mm, moreover, corresponding to the different memory cards 2 having compatibleness with the first interface unit 13, the total number of the metal pins lies between 1-20. In addition, as shown in FIG. 3, the connecting unit 12 having a plurality of connecting terminals 121, wherein an end 1211 of the plurality of connecting terminals 121 connect to the first interface unit 13.

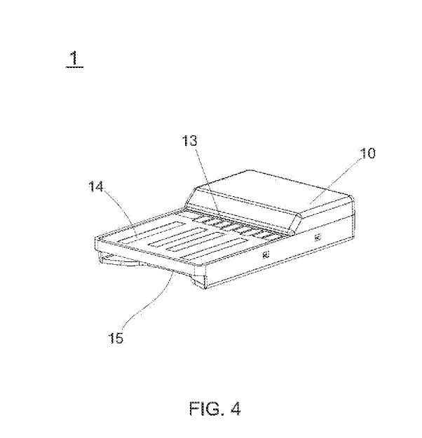

Referring to FIG. 4, which illustrates a whole stereo diagram of the practical embodiment of the card-reading device according to the present invention, as shown in FIG. 4, the central processing unit 11 and the connecting unit 12 can be covered and the printed circuit board 17 can be partially covered by using a housing 10, and the housing 10 is able to protect the central processing unit 11 and the connecting unit 12 from directly contacting with the outside objects, moreover, the first interface unit 13 and the second interface unit 14 disposed on the printed circuit board 17 are exposed out of the housing 10, and the accommodating unit 15 is disposed on one end of the housing 10 for inserting the memory card 2.

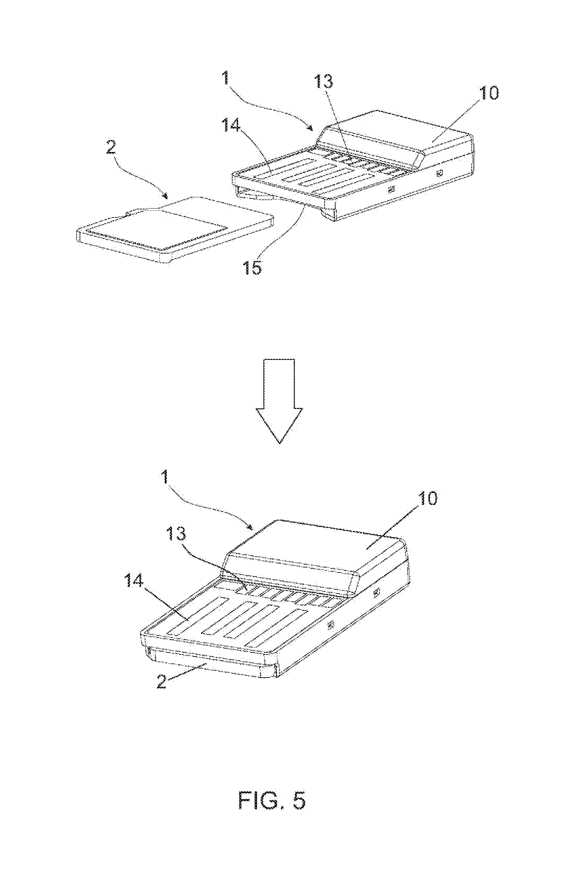

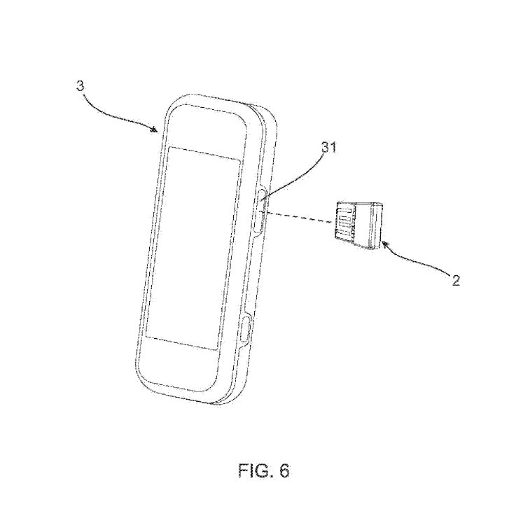

Referring to FIG. 5, which illustrates a schematic diagram of the memory card being accommodated in the card-reading device, as shown in FIG. 5, after inserting the memory card 2 into the accommodating unit 15, the memory card 2 is fixed in the accommodating unit 15, meanwhile, the memory card 2 electrically connects to the plurality of connecting terminals 121 of the connecting unit 12, and then the memory card 2 and the card-reading device 1 are integrated into one device. Referring to FIG. 6, which illustrates the schematic diagram of the card-reading device being combined with the first electronic device, as shown in FIG. 6, after the card-reading device 1 is combined with the memory card 2, a user can insert the card-reading device 1 into the memory connection port 31 of the first electronic device 3, wherein the first electronic device 3 shown in the FIG. 6 is a smart cell phone. Therefore, by means of the first interface unit 13 and the connecting unit 12 of the card-reading device 1, the first electronic device 3 is able to access the memory card 2.

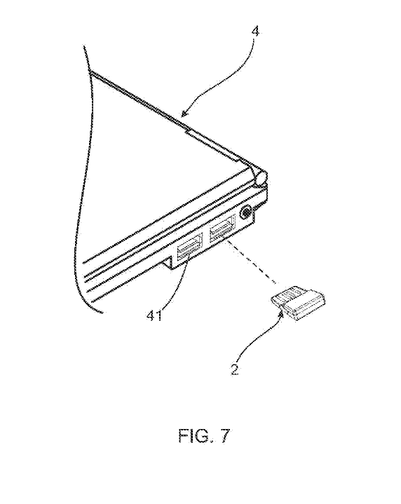

Moreover, referring to FIG. 7, which illustrates the schematic diagram of the card-reading device being combined with the second electronic device, as shown in FIG. 7, the card-reading device 1 combined with the memory card 2 can not only be inserted into the memory connection port 31 of the smart cell phone, but also can be inserted into the USB connection port 41 of the second electronic device 4, wherein the second electronic device 4 shown in FIG. 7 is the notebook. Therefore, after the card-reading device 1 is inserted into the notebook, by way of the second interface unit 14 and the central processing unit 11 of the card-reading device 1, the notebook is able to access the memory card 2.

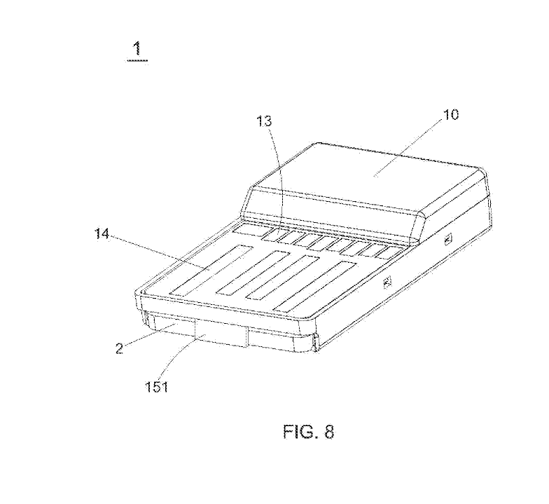

Continuously referring to FIG. 8, which illustrates a second stereo diagram of the practical embodiment of the card-reading device according to the present invention, as shown in FIG. 8, a blocking portion 151 is added to an opening of the accommodating unit 15 and capable of preventing the memory card 2 from sliding out after the memory card 2 is disposed in the accommodating unit 15, moreover, the opening of the accommodating unit 15 can be designed to a recess-like opening, so as to facilitate the user to withdraw the memory card 2.

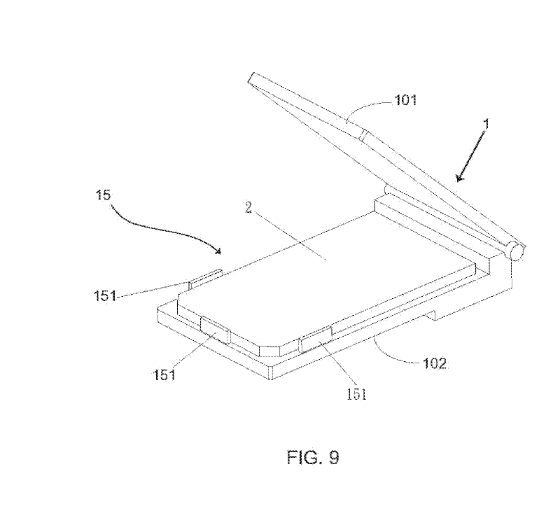

Furthermore, for increasing the functionality of the card-reading device 1 of the present invention, please refer to FIG. 9, which illustrates the stereo diagram of a second embodiment of the card-reading device according to the present invention, as shown in FIG. 9, the housing 10 is designed to a flip housing having a upper cover 101 and a lower cover 102, wherein the accommodating unit 15 is formed between the upper cover 101 and the lower cover 102. If the user desires to dispose the memory card 2 into the accommodating unit 15 of the card-reading device 1, the user needs to open the upper cover 101 firstly, then, to dispose the memory card 2 in the lower cover 102, and then, to close the upper cover 102; therefore, the memory card 2 is inserted into the accommodating unit 15 of the card-reading device 1. Moreover, as shown in FIG. 9, in the second embodiment of the card-reading device 1, three blocking portion 151 are disposed around the lower cover 102 for preventing the memory card 2 from sliding out.

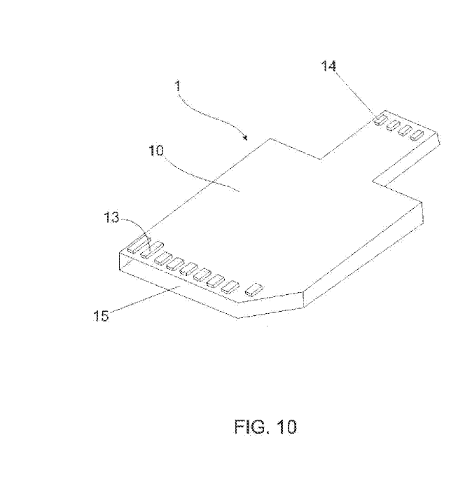

Referring to FIG. 10, which illustrates the stereo diagram of a third embodiment of the card-reading device according to the present invention, as shown in FIG. 10, the first interface unit 13 and the second interface unit 14 are formed in two opposite end of the card-reading device 1, wherein corresponding to the different memory cards 2 having compatibleness with the first interface unit 13, the first interface unit 13 can be an SMC memory card interface unit, a CF memory card interface unit, an xD memory card interface unit, an MMC memory card interface unit, a RS-MMC memory card interface unit, an SD memory card interface unit, an MS Duo memory card interface unit, or a Mini SD memory card interface unit. Moreover, as shown in FIG. 10, comparing to the first embodiment described above, the end formed the first interface unit 13 of the housing 10 is designed to more wide, such that the first interface unit 13 is able to get the compatibility with more kinds of memory cards 2. However, because the first interface unit 3 is used for connecting the memory connection port 31 of the first electronic device 3, such as the cell phone, so that, generally, the first interface unit 13 is designed to the SD memory card interface unit and the Mini SD memory card interface unit.

In addition, the same to the first embodiment, in the above-mentioned third embodiment of the card-reading device 1, the second interface unit 14 is the USB interface unit, wherein after the second interface unit 14 is connected to the USB connection port 41 of the second electronic device 4, such as the notebook, the second electronic device 4 is able to access the memory card 2 through the second interface unit 14 and the central processing unit 11.

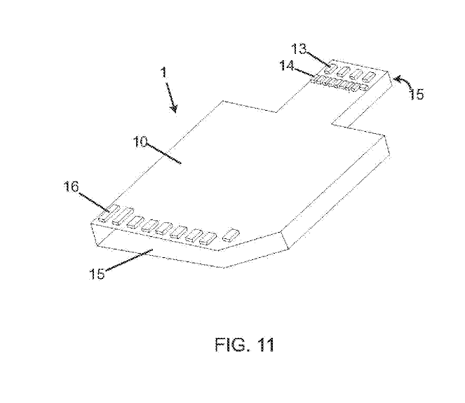

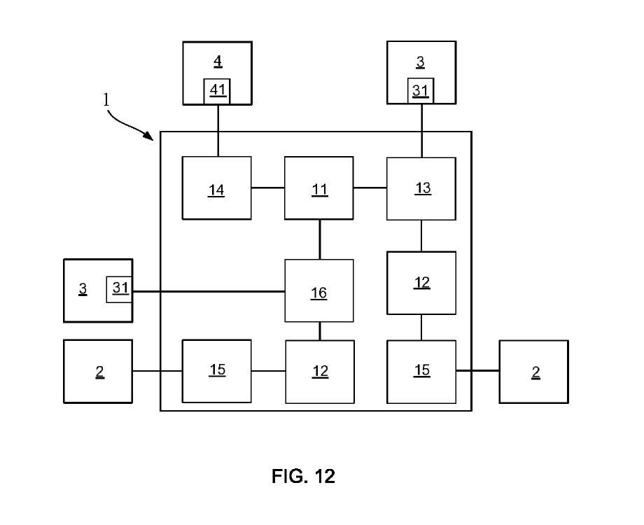

Referring to FIG. 11, which illustrates the stereo diagram of a fourth embodiment of the card-reading device according to the present invention, and referring to FIG. 12, which illustrates the block framework diagram of the fourth embodiment of the card-reading device according to the present invention. As shown in FIG. 11 and FIG. 12, and comparing to the aforesaid first embodiment of the card-reading device, wherein a third interface unit 16, an additional connecting unit 12 and an additional accommodating unit 15 are added in the fourth embodiment of the card-reading device 1. Besides, in the fourth embodiment of the card-reading device 1, the first interface unit 13, the second interface unit 14 and the third interface unit 16 are disposed in two end of the card-reading device 1, respectively, and the first interface unit 13 and the second interface unit 14 are in the same end of the card-reading device 1. As shown in FIG. 12, the first interface unit 13 connects to the connecting unit 12 and the central processing unit 11, the third interface unit 14 connects to the additional connecting unit 12 and the central processing unit 11; moreover, as shown in FIG. 11, two accommodating unit 15 are oppositely formed in two end of the card-reading device 1.

Referring to FIG. 11 and FIG. 12 again, the first interface unit 13 is a Micro SD memory card interface unit, in addition, the same to the first embodiment, the second interface unit 14 is the USB interface unit. The third interface unit 16 is also the memory card interface unit, wherein according to the different memory cards 2 having compatibleness with the third interface unit 16, the third interface unit 16 can be an MC memory card interface unit, a CF memory card interface unit, an xD memory card interface unit, an MMC memory card interface unit, a RS-MMC memory card interface unit, an SD memory card interface unit, an MS Duo memory card interface unit, a Mini SD memory card interface unit, or a Micro SD memory card interface unit. The third interface unit 16 is made up of a plurality of metal pins, and the width sizes of the metal pins are ranged between 15 mm to 37 mm, moreover, corresponding to the different memory cards 2 having compatibleness with the third interface unit 16, the total number of the metal pins lies between 1-18.

In the fourth embodiment of the card-reading device 1 described above, both the first interface unit 13 and the third interface unit 16 are able to be inserted into the memory connection port 31 of the first electronic device 3, such as the cell phone, wherein when the third interface unit 16 is inserted into the memory connection port 31, meanwhile, the first electronic device 3 can access the memory card 2 through the third interface unit 16 and the additional connecting unit 12.

It needs to note that, in the fourth embodiment of the card-reading device 1, Since the MMC memory card interface unit (having 7 metal pins), the RS-MMC memory card interface unit (having 7 metal pins) and the SD memory card interface unit (having 9 metal pins) have the same width size (24 mm) of metal pin, the MMC memory card interface unit, the RS-MMC memory card interface unit and the SD memory card interface unit can be simultaneously implemented in the single third interface unit 16, thus, the third interface unit 16 is compatible with an MMC memory card, a RS-MMC memory card and an SD memory card. Similarly, since the MS Dou memory card interface unit (having 10 metal pins) and the Mini SD memory card interface unit (having 11 metal pins) have the same width size (20 mm) of metal pin, the MS Dou memory card interface unit and the Mini SD memory card interface unit may be simultaneously implemented in the single first interface unit 13.

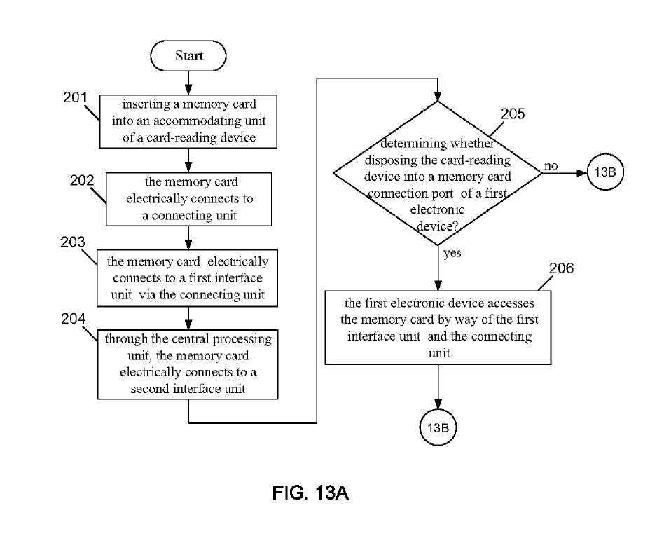

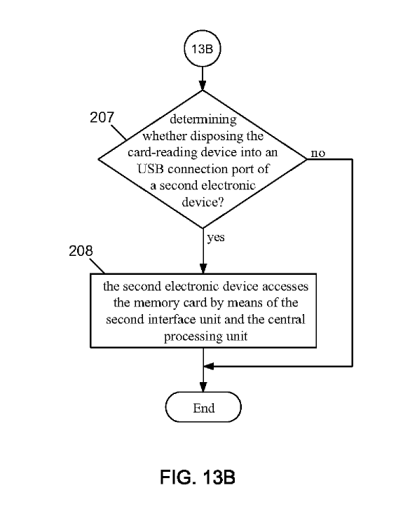

Thereof, all embodiments of the card-reading device according to the present invention have been clearly disclosed, furthermore, please refer to FIG. 13A and FIG. 13B, which illustrate flow charts view of the method for using the card-reading device to access the memory card according to the present invention, as shown in FIG. 13A, and FIG. 13B, the method for using the card-reading device to access the memory card includes the steps of:

Firstly, executing step (201), inserting the memory card 2 into the accommodating unit 15 of the card-reading device 1, next proceeding to step (202), the memory card electrically connects to the connecting unit 12, then, proceeding to step (203), the memory card 2 electrically connects to the first interface unit 13 via the connecting unit 12, and then proceeding to step (204), through the central processing unit 11, the memory card 2 electrically connects to the second interface unit 14. After the memory card 2 is inserted into the accommodating unit 15 and connects to the first interface unit 13 and the second interface unit 14 the of the card-reading device 1, the steps is proceeded to step (205), determining whether disposing the card-reading device 1 into the memory card connection port 31 of the first electronic device 3, if yes, proceeding to step (206), the first electronic device 3 accesses the memory card 2 by way of the first interface unit 13 and the connecting unit 12, and if no, proceeding to step (207), determining whether disposing the card-reading device 1 into the USB connection port 41 of the second electronic device 4, if yes, proceeding to step (208), the second electronic device 4 accesses the memory card 2 by means of the second interface unit 14 and the central processing unit 11, and if no ending the steps.

Thus, through the first embodiment, the second embodiment, the third embodiment, the fourth embodiment, and the flow chart of the method, the card-reading device and the method for using the card-reading device to access the memory card of the present invention have been completely and clearly disclosed in the above description, and in summary, the present invention has the following advantages:
1. The present invention integrated the first interface unit and the second interface unit into one card-reading device, so as to make the card-reading device capable of being selectively connected to the cell phone having the memory card connection port or the notebook (computer) having the USB connection port without any other conversion interfaces/devices, such that, it is very convenient for the user to backup the data stored in the memory card.
2. Inheriting to aforesaid point (1), by way of the card-reading device of the present invention, it can avoid the memory card from being repeatedly inserted into and withdraw from the memory card slot and the card reader, so that, it prevents the metal pins of the memory card from damage, so as to extend the lifetime of the memory card; moreover, in the present invention, the card-reading device further has the blocking potion to protect the memory card from sliding out.
3. In the present invention, the different memory cards having the same width size of the metal pins is integrated into single interface unit, so that, the single interface unit of the card-reading device is compatible with at least two kinds of memory card.
4. Moreover, by means of the method for using the card-reading device to access the memory card, the card-reading device can selectively be inserted into the USB connection port or the memory card connection port, such that the notebook (computer) or the cell phone can access memory card accommodated in the card-reading device.

The above description is made on embodiments of the present invention. However, the embodiments are not intended to limit scope of the present invention, and all equivalent implementations or alterations within the spirit of the present invention still fall within the scope of the present invention.

I claim:

1. A card-reading device, comprising:
a central processing unit;
at least one connecting unit;
at least two interface unit, having a first interface unit connecting to the central processing unit and the connecting unit, and a second interface unit connecting to central processing unit; and
at least one accommodating unit, being adapted for accommodating an external memory card;
wherein the first interface unit is compatible with the memory card, and the memory card may connect to the first interface unit via the connecting unit; moreover, through the central processing unit, the memory card being capable of connecting to the second interface unit.

2. The card-reading device of claim 1, wherein the central processing unit, the connecting unit, the first interface unit, and the second interface unit can be implemented on a printed circuit board, and the central processing unit and the connecting unit being covered and the printed circuit board being partially covered by using a housing.

3. The card-reading device of claim 1, wherein the first interface unit is a memory card interface unit, which can connect to a memory card connection port of a first electronic device, so that the first electronic device is able to access the memory card through the first interface unit and the connecting unit.

4. The card-reading device of claim 3, wherein the first interface unit is made up of a plurality of metal pins, and a width size of the metal pins being ranged between 10 mm to 40 mm, moreover, corresponding to the different memory cards having compatibleness with the first interface unit, the total number of the metal pins lying between 1-20.

5. The card-reading device of claim 3, wherein the first interface unit is selected from the group consisting of: an SMC memory card interface unit, a CF memory card interface unit, an xD memory card interface unit, an MMC memory card interface unit, a RS-MMC memory card interface unit, an SD memory card interface unit, an MS memory card interface unit, an MS Duo memory card interface unit, a Mini SD memory card interface unit, and a Micro SD memory card interface unit.

6. The card-reading device of claim 3, wherein the first electronic device is selected from the group consisting of: a cell phone, a host, a notebook, a multimedia player, digital camera, and a multi-card reader.

7. The card-reading device of claim 1, wherein the second interface unit is an USB interface unit capable of connecting to an USB connection port of a second electronic device, so that the second electronic device is able to access the memory card through the second interface unit and the central processing unit.

8. The card-reading device of claim 7, wherein the second electronic device is selected from the group consisting of: a host, a notebook and a multimedia player.

9. The card-reading device of claim 1, wherein the connecting unit has a plurality of connecting terminals, and an end of the plurality of connecting terminals connecting to the first interface unit.

10. The card-reading device of claim 1, further comprising a third interface unit being a memory card interface unit and capable of connecting to the memory card connection port of a first electronic device, so that the first electronic device is able to access the memory card through the third interface unit and the connecting unit.

11. The card-reading device of claim 10, wherein the third interface unit is made up of a plurality of metal pins, and a width size of the metal pins being ranged between 10 mm to 40 mm, moreover, corresponding to the different memory card having compatibleness with the first interface unit, the total number of the metal pins lying between 1-20.

12. The card-reading device of claim 10, wherein the third interface unit is selected from the group consisting of: an SMC memory card interface unit, a CF memory card interface unit, an xD memory card interface unit, an MMC memory card interface unit, a RS-MMC memory card interface unit, an SD memory card interface unit, an MS memory card interface unit, an MS Duo memory card interface unit, a Mini SD memory card interface unit, and a Micro SD memory card interface unit.

13. The card-reading device of claim 1, further comprising a blocking portion disposed at an opening of the accommodating unit, blocking portion is used for preventing the memory card in the accommodating unit from sliding out.

14. The card-reading device of claim 1, wherein the housing can be designed to a flip housing having a upper cover and a lower cover, and the accommodating unit being formed between the upper cover and the lower cover.

15. A method for using a card-reading device to access a memory card, comprising the steps of:
(1) inserting a memory card into an accommodating unit of a card-reading device;
(2) the memory card electrically connecting to a connecting unit;
(3) the memory card electrically connecting to a first interface unit via the connecting unit;
(4) through the central processing unit, the memory card electrically connecting to a second interface unit;
(5) determining whether disposing the card-reading device into a memory card connection port of a first electronic device, if yes, proceeding to step (6), and otherwise, proceeding to step (7);
(6) the first electronic device accessing the memory card by way of the first interface unit and the connecting unit;
(7) determining whether disposing the card-reading device into an USB connection port of a second electronic device, if yes, proceeding to step (8), and otherwise, ending the steps; and
(8) the second electronic device accessing the memory card by means of the second interface unit and the central processing unit.
